(19) United States
(12) Patent Application Publication
(10) Pub. No.: US 2009/0147759 A1
(43) Pub. Date: Jun. 11, 2009

(54) METHOD AND APPARATUS FOR SUPPORTING MOBILITY OF NODE USING LAYER 2/LAYER 3 ADDRESSES

(75) Inventors: Tai-won UM, Daejeon (KR); Won Ryu, Daejeon (KR); Kyoung-hee Lee, Daejeon (KR); Eun-jun Rhee, Daejeon (KR); Seong-gon Choi, Cheongju (KR)

Correspondence Address: LAHIVE & COCKFIELD, LLP;FLOOR 30, SUITE 3000, ONE POST OFFICE SQUARE, BOSTON, MA, 02109, US

(73) Assignees: Electronics & Telecommunications Research Institute, Daejeon (KR); Chungbuk National University Industry Academic Cooperation Foundation, Cheongju (KR)

(21) Appl. No.: 12/134,907

(22) Filed: Jun. 6, 2008

(30) Foreign Application Priority Data
Dec. 10, 2007 (KR) 10-2007-0127874
Mar. 18, 2008 (KR) 10-2008-0024909

(51) Int. Cl. H04Q 7/24

(52) U.S. Cl. 370/338

(57) ABSTRACT

Provided is a network-based mobility supporting method for supporting mobility of a node not having a mobility supporting function. The network-based mobility supporting method which is performed by a plurality of agents that connect a plurality of access networks to an Internet protocol core network integrating the plurality of access networks, includes: acquiring address information of a mobile node connected to an access point from the access point; transmitting the address information of the mobile node and layer 3 address information of an agent to a management unit which is located on the Internet protocol core network and manages the plurality of access networks, and registering a location of the mobile node; transmitting the layer 3 address information of the correspondent agent to the mobile node, in order to allow the mobile node to transmit a data packet to the agent; and receiving and transmitting the data packet between the mobile node and a correspondent node in consideration of the address information of the mobile node and information registered in the management unit. Therefore, it is possible to provide high-speed mobility to a mobile node.

### CROSS REFERENCE TO RELATED APPLICATIONS

This application claims priority from Korean Patent Application No. 10-2007-0127874, filed on Dec. 10, 2007, and No. 10-2008-0024909, filed on Mar. 18, 2008, the disclosures of which are incorporated herein in its entirety by reference.

### BACKGROUND OF THE INVENTION

1. Field of the Invention

The present invention relates to an Internet Protocol (IP)-based network, and more particularly, to a technology for supporting mobility of a mobile node (MN).

This work was supported by the IT R&D program of Ministry of Information and Communication (MIC)/Institute for Information Technology Advancement (IITA) [2006-S-058-02, Development of Network/Service Control Technology in All-IP based Converged network].

2. Description of the Related Art

Technologies for supporting mobility of a mobile node (MN) on a general IP-based network include a mobile IP (MIP) defined by the Internet Engineering Task Force (IETF). Such IP-based mobility supporting technologies operate on Layer 3 (L3), so they are called L3 mobility technologies. The L3 mobility technologies operate when processing related to movement of a mobile node on a Layer 2 (L2) is complete, and perform processes of registration to a location manager and message transmission through L3 routing for the registration. During the processes, time delay is generated, the mobile node cannot perform communications for the delayed time, and communications may be even interrupted if the delay time is too long. For this reason, fast mobility processing becomes an important technical element in mobility technologies, and accordingly, new approach and improvement on existing L3 mobility technologies are required.

### SUMMARY OF THE INVENTION

The present invention provides a method for minimizing delay due to processing of mobility of a mobile node.

According to an aspect of the present invention, there is provided a method of supporting mobility of a mobile node, the method performed by a plurality of agents that connect a plurality of access networks to an Internet protocol core network integrating the plurality of access networks, the method including: acquiring address information of a mobile node connected to an access point from the access point; transmitting the address information of the mobile node and layer 3 address information of an agent to a management unit which is located on the Internet protocol core network and manages the plurality of access networks, and registering a location of the mobile node in the management unit; transmitting the layer 3 address information of the agent to the mobile node, in order to allow the mobile node to transmit a data packet to the agent; and receiving and transmitting the data packet between the mobile node and a correspondent node on the basis of the address information of the mobile node and information registered in the management unit.

According to another aspect of the present invention, there is provided a method of supporting mobility of a node located on an Internet protocol core network and wirelessly connected to an access point, the method performed by a management unit capable of communicating with an agent for each access network, the agent managing the node, the method including: acquiring layer 2 address information and permanent address information of the node, and layer 3 address information of the agent for each access network, from the agent for each access network; mapping and managing the layer 2 address information and the permanent address information of the node and the layer 3 address information of the agent; receiving a request message for requesting layer 3 address information of a receiving party agent which manages a correspondent node, from a transmitting party agent which tries to transmit a data packet to the correspondent node; searching for the layer 3 address information of the receiving party agent from the layer 2 address information and the permanent address information of the node and the layer 3 address information of the agent, in response to the request message; and transmitting the layer 3 address information of the receiving party agent to the transmitting party agent.

According to another aspect of the present invention, there is provided a method of supporting mobility of a mobile node, the method performed by an access point communicating with an agent which connects an access network to an Internet protocol core network, the method including: forming a wireless channel with a mobile node; acquiring layer 2 address information of the mobile node when the wireless channel is formed; and transmitting the layer 2 address information of the mobile node to an agent for registering a location of the mobile node, instead of the mobile node.

According to another aspect of the present invention, there is provided an apparatus of supporting mobility of a mobile node for each access network, the apparatus which connects an access network to an Internet protocol core network integrating the plurality of access networks, the apparatus including: a management unit managing information related to a mobile node connected to an access point, and managing information related to a correspondent node connected to an access point of a different access network; and a reception/transmission processor receiving and transmitting a data packet between the mobile node and the correspondent node using the information managed by the management unit.

According to another aspect of the present invention, there is provided a management apparatus for communicating with an agent for each access network, the management apparatus located on an Internet protocol core network, the agent managing a node wirelessly connected to an access point, the management apparatus including: a central management unit managing permanent address information of a plurality of nodes connected to an access point, and layer 3 address information of an agent for managing the plurality of nodes, and managing communication connections between the plurality of nodes; and transmitting permanent address information of a correspondent node managed by the central management unit, and layer 3 address information of an agent managing the correspondent node, in response to a request of an agent which manages a mobile node trying to communicate with the correspondent node, and transmitting permanent address information of the mobile node managed by the central management unit and layer 3 address information of the agent managing the mobile node, to the correspondent node.

Therefore, a high-speed mobility service for a mobile node is provided in an IP network environment. Accordingly, it is possible to reduce delay due to mobility processing through a L2 trigger function and high-speed mobility signaling through a predetermined control channel. Particularly, it is possible to provide a high-speed mobility supporting service which can quickly perform mobility processing through a L2 trigger when a node moves, allow fast message transmission through a pre-set control channel between HCA and MICS, and omit a process of transmitting information separately to a mobile node or to a correspondent node through tunneling supported by each HCA.

Additional aspects of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 shows a configuration of a network environment according to an embodiment of the present invention;

FIG. 2 is a flowchart for explaining a process for registering a location and address of a mobile node, according to an embodiment of the present invention;

FIG. 3 is a flowchart for explaining processes of connection registration and tunneling for data transmission and reception between two nodes, according to an embodiment of the present invention;

FIG. 4 is a flowchart for explaining a handover process when a node moves to a new access network area;

FIG. 5 is a block diagram of a mobility supporting apparatus according to an embodiment of the present invention;

FIG. 6 is a block diagram of a mobility management apparatus according to an embodiment of the present invention;

FIG. 7 shows a first example of a table managed by the mobility management apparatus;

FIG. 8 shows a second example of a table managed by the mobility management apparatus;

FIG. 9 shows a third example of a table managed by the mobility management apparatus; and

FIG. 10 shows a fourth example of a table managed by the mobility management apparatus.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

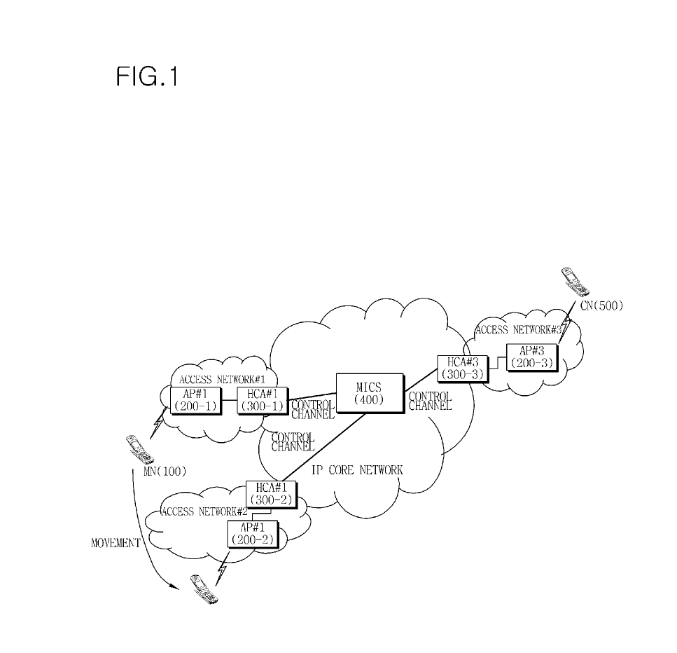

FIG. 1 shows a configuration of a network environment according to an embodiment of the present invention.

An access point (hereinafter, referred to as an “AP”) 200-1, 200-2 or 200-3, which is a wireless access device, can communicate with a network connection equipment for connecting an access network to an Internet Protocol (IP) core network. In this specification, the network connection equipment, which is a mobility supporting apparatus for supporting mobility of a node, is called a Handover Control Agent (HCA) 300-1, 300-2 or 300-3. An AP (for example, AP#1 200-1) extracts a L2 address of a mobile node 100 through a Layer 2 (L2) connection with the mobile node 100, and transmits the L2 address of the mobile node 100 to a HCA (for example, HCA#1 300-1) which is in a local area.

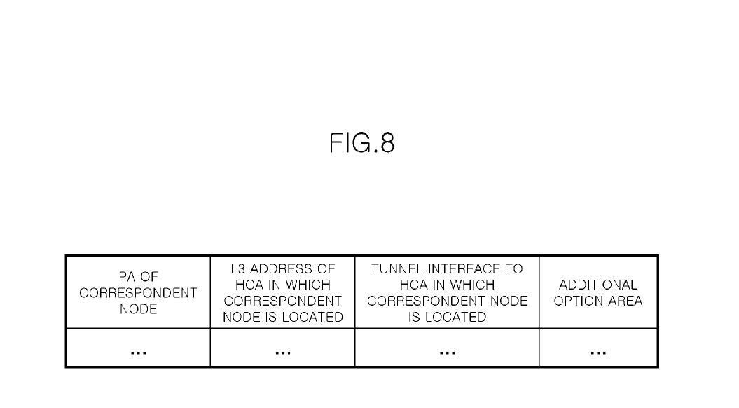

The HCA#1 300-1 is located in an edge area on the IP core network, and maintains and manages information, such as permanent addresses (PAs), L2 addresses, and local addresses (LAs) of nodes that belong to the corresponding area, and information for interfacing with the AP#1 200-1 in which the nodes are located, wherein the PAs means IP addresses not changed when the nodes perform handover to another access network area, and the information is managed in the form of a local node address management table (LNAT). Also, the HCA#1 300-1 manages permanent addresses of correspondent nodes with which the nodes located in the access network area to which the HCA#1 300-1 belongs want to communicate, L3 addresses of HCAs in which the correspondent nodes are located, and addresses of tunnel interfaces to the HCAs in which the correspondent nodes are located. The address information is managed in the form of a correspondent node address management table (CNAT) illustrated in FIG. 8. Also, the HCA#1 300-1 performs encapsulation and decapsulation on data packets. For example, the HCA#1 300-1 encapsulates a data packet received from the mobile node 100 and transmits the encapsulated data packet to a correspondent node 500, and decapsulates a data packet received for the correspondent node 500 and transmits the decapsulated data packet to the mobile node 100.

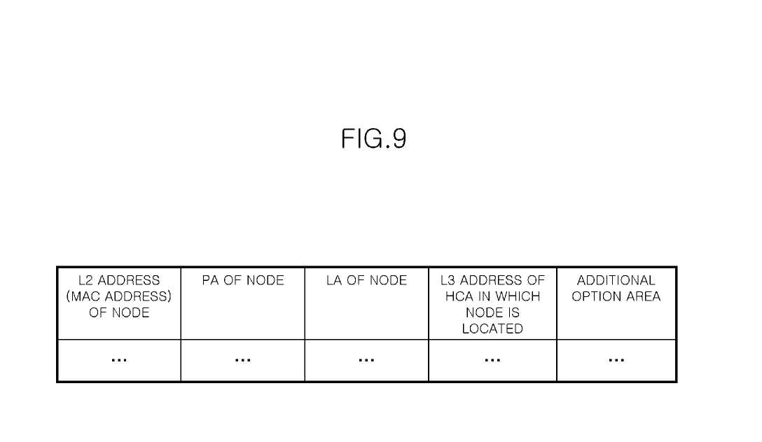

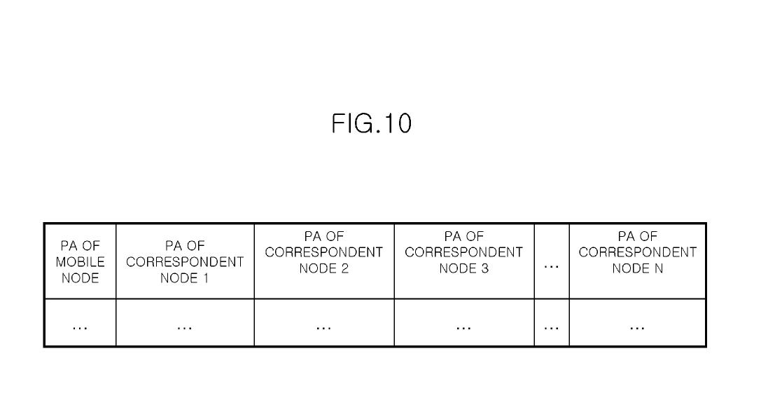

Meanwhile, a mobility information control server (MICS) 400 located on the IP core network functions to manage the locations of the nodes, and may be installed in a high-performance server, router or switch. The MICS 400 receives information about L2 addresses and local addresses (LAs) of the nodes and L3 addresses of HCA#1 300-1, HCA#2 300-2, and HCA#3 300-3 in which the nodes are located, from the HCA#1 300-1, HCA#2 300-2, and HCA#3 300-3, and maintains and manages the information. The information is managed in the form of a global location management table (GLMT) illustrated in FIG. 9. Also, the MICS 400 maintains and manages information about communication connections between the nodes, and the information is managed in the form of a communicating node mapping table (CNMT) illustrated in FIG. 10. The MICS 400 which manages the GLMT and CNMT provides the information to the HCA#1 300-1, HCA#2 300-2, and HCA#3 300-3.

There is at least one dynamic control channel or at least one pre-set control channel between the MICS 400 and a HCA (for example, HCA#1 300-1). The control channel may be used for traffics to process mobility of the nodes. If a multiprotocol label switching (MPLS) technique is applied to the IP core network, a Label Switched Path (LSP) is established between the MICS 400 and HCA#1 300-1 and used as a control channel for receiving and transmitting mobility signaling parameters.

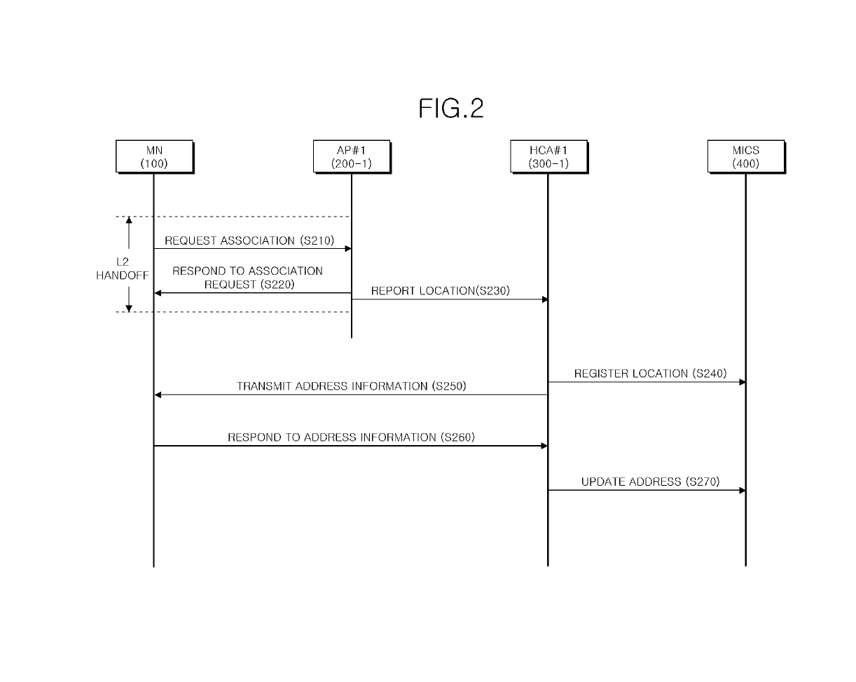

FIG. 2 is a flowchart for explaining a process for registering a location and address of a mobile node 100 based on a network, according to an embodiment of the present invention. Referring to FIG. 2, a process of registering an initial location and address of the mobile node 100 when the mobile node 100 initially accesses an access network connected to an IP core network will be described. The process is an initial setting process for restoring information related to the mobile node 100 due to data loss because the mobile terminal 100 has not accessed the access network for a long time.

Referring to FIGS. 1 and 2, if the mobile node 100 enters an access network #1, L2 handoff for establishing a wireless channel with an AP#1 200-1 is performed. In the L2 handoff, the AP#1 200-1 receives a L2 association request from the mobile node 100, acquires an L2 address which is location information of the mobile node 100 through a L2 trigger function, and sends an association response to the mobile node 100 (operations S210 and S220). Simultaneously, the AP#1 200-1 transmits the L2 address of the mobile node 100 to a HCA#1 300-1 to which the AP#1 200-1 belongs, using a location report message (operation S230). The L2 address of the mobile node 100 may be an “Ethernet 48-Bbit MAC address”, “3GPP2 International Mobile Station Identity and Connection ID”, “3GPP2 International Mobile Subscriber Identity”, or “64-bit Global ID, EUI-64”. Also, the L2 association means forming a wireless channel using a Layer 2 protocol (for example, a wireless MAC protocol based on the IEEE 802.11 standard) between a node and AP. When a wireless MAC protocol is exchanged between a node and AP, the AP will acquire a L2 address such as a MAC of the node.

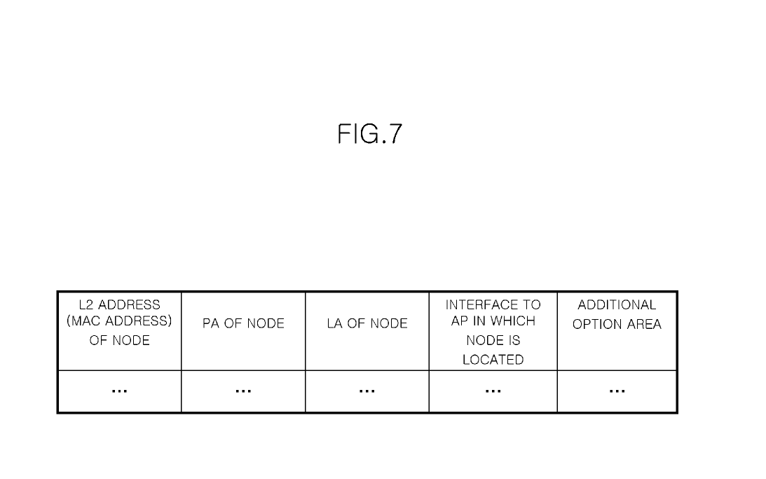

The HCA#1 300-1 records the L2 address of the mobile node 100 included in the location report message in a LNAT illustrated in FIG. 7. In some cases, the HCA#1 300-1 generates a LA (a L3 address) which is available in an area managed by the HCA#1 300-1, maps the LA to a L2 address, and records the result of the mapping in the LNAT. Also, the HCA#1 300-1 transmits the L2 address and LA of the mobile node 100 and the L3 address of the HCA#1 300-1 to the MICS 400 (operation S240). The L3 address of the HCA# 300-1 may be an IPv4 or IPv6 address. The MICS 400 receives a location registration message from the HCA#1 300-1, creates a record about the mobile node 100 in the GLMT, and records in the created record the L2 address and LA of the mobile node 100 and the L3 address of the HCA#1 3001 which are included in the location registration message.

Meanwhile, the HCA#1 300-1 transmits the L3 address of the HCA#1 300-1 to the mobile node 100 using an address information message, and in some cases, transmits a LA that will be used by the mobile node 100 to the mobile node 100 (operation S250). Here, the LA means a temporary L3 address (for example, an IP address) which the mobile node 100 can use in the access network #1. When the HCA#1 300-1 cannot check paths of nodes which have to be managed by the HCA#1 300-1 since the number of the nodes are too large, the mobile node 100 generates LAs that are to be used in the access network#1 and allocates the LAs to the nodes, thereby allowing the HCA#1 300-1 to easily manage the nodes that are connected thereto. Accordingly, in the case of a network environment requiring such management, a process of allowing a HCA to generate and allocate LAs is needed.

The mobile node 100 receives an address information message, and changes its own default gateway address to a L3 address of the HCA#1 300-1 included in the address information message. Accordingly, the mobile node 100 can transmit a data packet using the default gateway address. Also, the mobile node 100 transmits an address information response message to the HCA#1 300-1 in response to the address information message. At this time, the mobile node 100 adds PA information of the mobile node 100 to the address information response message, thus informing the HCA#300-1 of the PA of the mobile node 100 (operation S260). The HCA#1 300-1 receives the address information response message from the mobile node 100, extracts the PA of the mobile node 100 included in the address information response message, and records the PA of the mobile node 100 in the corresponding record. Then, the HCA#1 300-1 informs the MICS 400 of the PA of the mobile node 100 using an address update message (operation S270). The MICS 400 receives the address update message from the HCA#1 300-1, extracts the PA of the mobile node 100 included in the address update message, and records the PA of the mobile node 100 in the corresponding record of the GLMT. Through the process, the location and address of the mobile node 100 are registered.

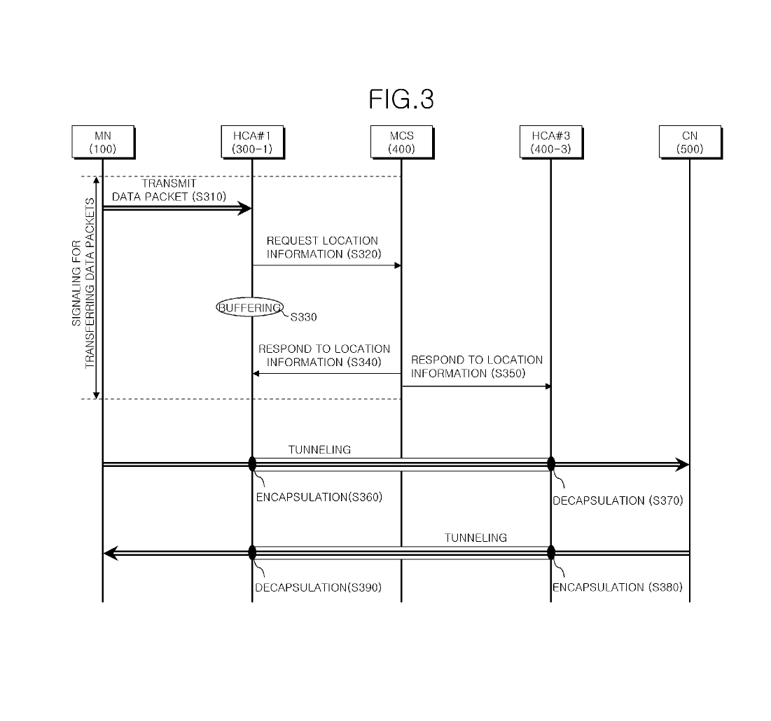

FIG. 3 is a flowchart for explaining a process for supporting mobility when data packets are transferred between two nodes, according to an embodiment of the present invention.

A mobile node 100 sends a data packet, like in a conventional packet network, to communicate with a correspondent node (CN) 500, using a default gateway address which is set through the process described above with reference to FIG. 2 (operation S310). Here, a destination address of the packet header of the data packet is set to a PA of the CN 500, and a source address of the packet header is set to a PA of the mobile node 100. The data packet which is initially sent is routed to a HCA#1 300-1 which functions as a default gateway of an area in which the mobile node 100 is located. The HCA#1 300-1 searches for the CNAT to find a L3 address of a HCA#3 300-3 mapped to the destination address of the received packet, using the PA of the correspondent node 500 which is the destination address of the received data packet. If the L3 address of the HCA#3 300-3 does not exist in the CNAT, the HCA#1 300-1 transmits a location information request message including the PA of the correspondent node 500 and the PA of the mobile node 100 to the MICS 400 (operation S320). The HCA#1 300-1 may buffer the data packet received from the mobile node 100 (operation S330).

The MICS 400 which receives the location information request message from the HCA#1 300-1 searches for a L3 address of the HCA#3 300-3 from a GLMT stored in the MICS 400 using the PA information of the correspondent node 500, and transmits a location information response message including the PA information of the correspondent node 500 and the L3 address of the HCA#3 300-3 to the HCA#1 300-1 (operation S340). Then, the MICS 400 maps the PA of the mobile node 100 to the PA of the correspondent node 50 and stores the result of the mapping in order to record communications between the mobile node 100 and the correspondent node 500. Also, the MICS 400 searches for the L3 address of the HCA#1 300-1 using the PA information of the mobile node 100, and transmits a location information transfer message including the PA information of the mobile node 100 and the L3 address of the HCA#1 300-1 to the HCA#3 300-3 (operation S350).

The HCA#1 300-1 and HCA#3 300-3 that receive the messages add information about the PAs and the L3 addresses of the other party HCAs included in the received messages, to CNATs stored in the respective HCA#1 300-1 and HCA#3 300-3. Through this process, information about the PAs of the other parties and the L3 addresses of the other party HCAs required for communications between the mobile node 100 and the correspondent node 500 is registered in the CNAT of the HCA#1 300-1 and the CNAT of the HCA#3 300-3. Through such registration, additional information spaces are allocated to the configuration tables LNAT, CNAT, GLMT, and CNMT, according to a development environment, thereby performing additional functions.

The HCA#1 300-1 which has completed the above process tunnels the data packet which the HCA#1 300-1 has buffered, and transmits the tunneled data packet to the HCA#1 300-1. When the HCA#1 300-1 and the HCA#3 300-3 are connected to an IP core network, a destination address of the packet header of the data packet is the HCA#3 300-3 in which the correspondent node 500 is located, and a source address of the packet header is the HCA#1 300-1 in which the mobile node 100 is located. The HCA#1 300-1 performs encapsulation and tunneling on the packet data and transmits the encapsulated and tunneled data packet to the HCA#3 300-3 (operation S360). The HCA#3 300-3 receives the data packet and performs decapsulation on the data packet (operation S370), then searches for the LNAT to find an interface to which an AP#3 200-3 in which the correspondent node 500 is located is connected, and transfers the data packet to the correspondent node 500 through the interface.

Also, when the correspondent node 500 transmits the data packet to the mobile node 100, if the correspondent node 500 sets a destination address of the data packet to a PA of the mobile node 100 and a source address of the packet data to a PA of the correspondent node 100, the HCA#3 300-3 encapsulates the packet header of the data packet to a packet header whose destination address is the HCA#1 300-1 in which the mobile node 100 is located and whose source address is the HCA#3 300-3, and transfers the resultant data packet to the HCA#1 300-1 (operation S380). The HCA#1 300-1 receives the data packet and performs decapsulation on the data packet (operation S390), then searches for the LNAT to find an interface to which an AP#1 200-1 in which the mobile node 100 is located is connected, and transfers the data packet to the mobile node 100 through the interface.

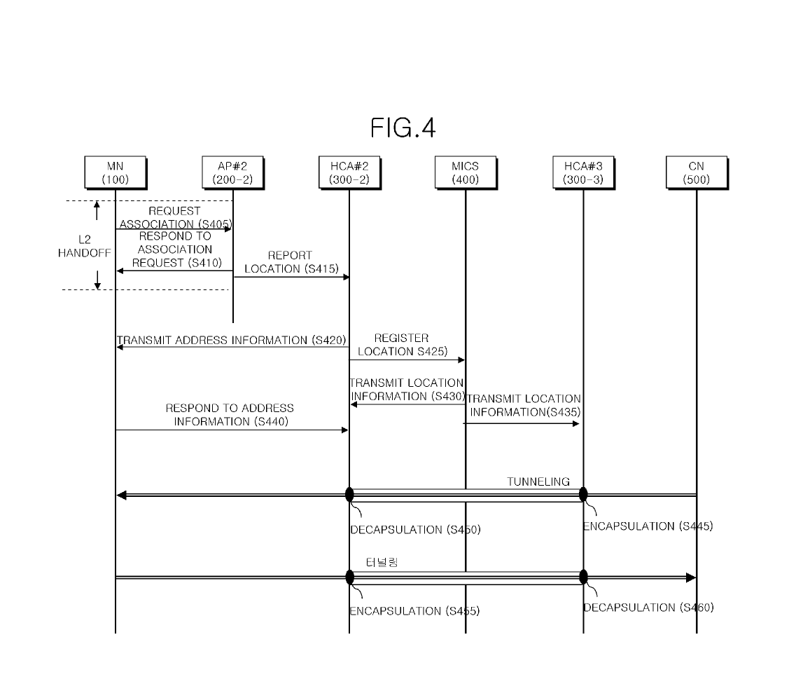

FIG. 4 is a flowchart for explaining a handover process when a node moves to a new access network area. FIG. 4 shows a process of registering in a MICS 400 a L3 address of a HCA#2 300-2 of a new access network area to which the mobile node 100 moves in order to achieve fast handover processing and stable communications with a correspondent node 500, and of performing communications between the HCA#2 300-2 and a HCA#3 300-3, when the mobile node 100 performing the data communication process described above with reference to FIG. 3 moves to the new access network area. Also, the process illustrated in FIG. 4 includes an operation of allocating a new LA address to the mobile node 100 when the moving node 100 requests a LA address.

When the moving node 100 moves to a new access network area, as illustrated in FIG. 1, an association request for establishing a wireless channel with an AP#2 200-2 is generated, and a L2 handoff process is performed according to a response to the association request (operations S405 and S410). In the L2 handoff process, the AP#2 200-2 acquires an L2 address of the mobile node 100 through an L2 trigger function, and transmits the L2 address of the mobile node 100 to a HCA#2 300-2 using a location report message (operation S415). The HCA#2 300-2 records the L2 address of the mobile node 100 in an LNAT. In some cases, the HCA#2 300-2 generates an LA that is to be temporarily allocated to the mobile node 100 and records the LA in the LNAT. The HCA#2 300-2 transmits an address information message including information about the LA and a L3 address of the HCA#2 300-2 to the mobile node 100, and simultaneously transmits a location registration message including a L2 address of the mobile node 100, the LA and the L3 address of the HCA#2 300-2, to the MICS 400, through a pre-set control channel (operations S420 and 425). The mobile node 100 receives the address information message, and transmits a response message to the HCA#2 300-2 (operation S440).

Meanwhile, the MICS 400 updates the L2 address of the mobile node 100, the LA, and the L3 address of the HCA#2 300-2, which exist in the GLMT, using the location registration message received from the HCA#2 300-2. If a record for the mobile node 100 exists in the CNMT, the mobile node 100 transmits to the HCA#2 300-2 a location information transfer message including a list of PAs of all correspondent nodes with which the mobile node 100 can communicate and L3 addresses of HCAs of network areas in which the correspondent nodes are located (operation S430). The HCAs which receive the location information transfer message from the MICS 400 update respective CNATs. Thereafter, the HCA#2 300-2 and HCA#3 300-3 perform tunneling on the basis of the CNAT information updated when a data packet is transferred (operations S445, S450, S455, and S460).

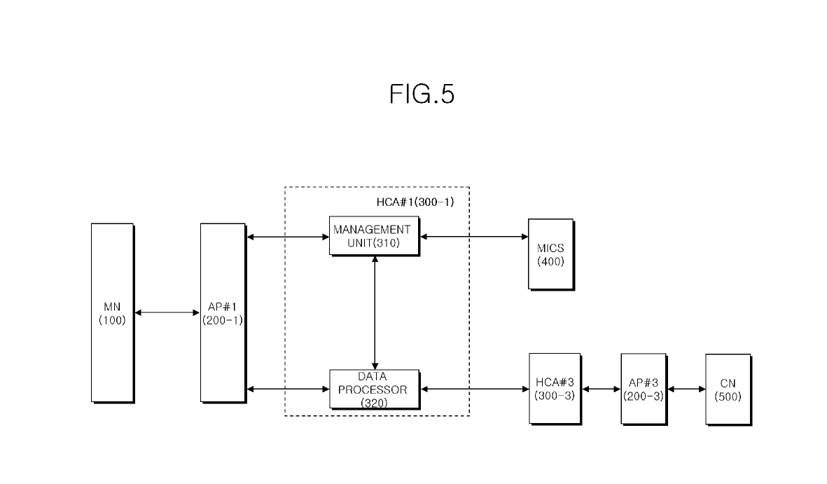

FIG. 5 is a block diagram of a HCA (HCA#1 300-1) according to an embodiment of the present invention.

As illustrated in FIG. 5, the HCA#1 300-1 includes a management unit 310 and a transmission/reception processor 320. The management unit 310 manages information related to a mobile node 100 connected to an AP#1 200-1 of an access network, and manages information related to a correspondent node (CN) 500 connected to an AP#2 200-1 of the other access network. In detail, the management unit 310 maintains and manages, in a LNAT, a L2 address, PA, and LA of a mobile node 100 and information about an interface to an AP#1 200-1 connected to the mobile node 100. Also, the management unit 310 maintains and manages, in a CNAT, a PA of the correspondent node 500, an L3 address of a HCA#3 300-3 of a network area in which the correspondent node 500 is located, and information about a tunnel interface to the HCA#3 300-3. Some of information managed in the LNAT and CNAT is acquired from the outside, which has been described above.

The transmission/reception processor 320 receives a data packet that is to be transmitted from the mobile node 100 to the correspondent node 500. Also, the transmission/reception processor 320 searches for the CNAT to find a PA matched to a destination address of the correspondent node 500 included in the data packet. Then, the transmission/reception processor 320 transmits the data packet to the HCA#3 300-3 through encapsulation and tunneling, using information about a L3 address of the HCA#2 300-2 mapped to the searched PA, and information about a tunnel interface to the HCA#3 300-3 in which the correspondent node 500 is located. Also, the transmission/reception processor 320 receives the data packet through the AP#3 200-3 and HCA#3 300-3 from the correspondent node 500, and performs decapsulation on the data packet. Then, the transmission/reception processor 320 searches for the LNAT to find a PA matched to the destination address of the received data packet. Then, the transmission/reception processor 320 extracts information about an interface to the AP#1 200-1 mapped to the searched PA, and transfers the data packet to an AP#1 200-1 using the extracted interface information.

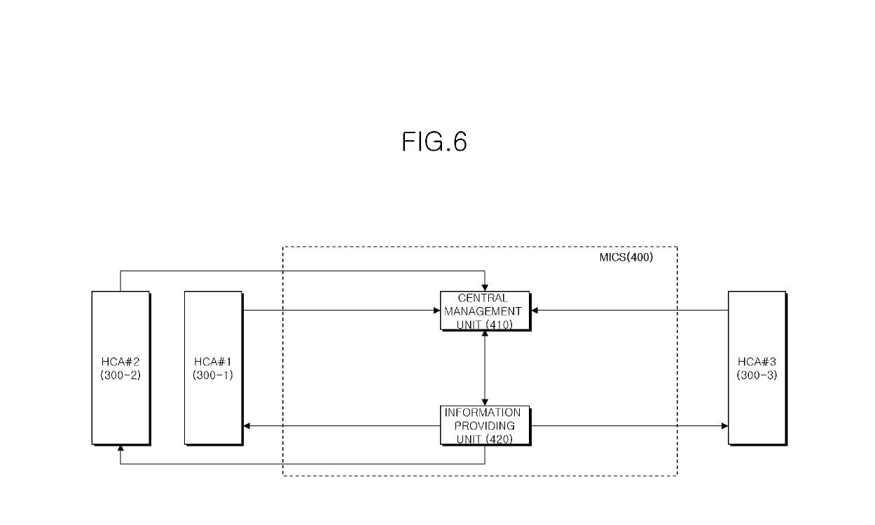

FIG. 6 is a block diagram of a MICS according to an embodiment of the present invention.

As illustrated in FIG. 6, the MICS 400 includes a central management unit 410 and an information provider 420. The central management unit 410 manages information about locations and communication states of nodes. In detail, the central management maps an L2 address, PA and LA of a mobile node to L3 address information of a HCA#1 300-1 of a network area in which the mobile node is located, and stores and manages the result of the mapping in a GLMT. As described above, the address information is provided from the HCA#1 300-1. The information providing unit 420 searches for the GLMT according to a request from the HCA#1 300-1 of the network area in which the node trying to communicate with a correspondent node is located, provides to the HCA#1 300-1 L3 address information of a HCA#3 300-3 of a network area in which the correspondent node is located, and provides to the HCA#3 300-3 a PA of the mobile node connected to the HCA#1 300-1 and L3 address information of the HCA#1 300-1. Then, the central management unit 410 records communication connection information between the mobile node and the correspondent node in a CNMT.

Then, if the mobile node moves to another access network area while the mobile node 100 communicates with an access network area, a HCA#2 300-2 of another access network area transmits the L2 address and LA of the mobile node and L3 address information of the HCA#2 300-2 to a MICS 400. The central management unit 410 of the MICS 400 receives the L2 address and LA of the mobile node and the L3 address information of the HCA#2 300-2, thus updating the GLMT. Then, the information providing unit 420 searches for the CNMT to check the correspondent node communicating with the mobile node, and transmits the PA address of the mobile node and the L3 address information of the HCA#2 300-2 to the correspondent node. Also, the information providing unit 420 transmits to the HCA#2 300-2 the PA of the correspondent node and the L3 address information of the HCA#3 300-3 of the network area in which the correspondent node is located.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method of supporting mobility of a mobile node, the method performed by a plurality of agents that connect a plurality of access networks to an Internet protocol core network integrating the plurality of access networks, the method comprising:
acquiring address information of a mobile node connected to an access point from the access point;
transmitting the address information of the mobile node and layer 3 address information of an agent to a management unit which is located on the Internet protocol core network and manages the plurality of access networks, and registering a location of the mobile node in the management unit;
transmitting the layer 3 address information of the agent to the mobile node, in order to allow the mobile node to transmit a data packet to the agent; and
receiving and transmitting the data packet between the mobile node and a correspondent node on the basis of the address information of the mobile node and information registered in the management unit.

2. The method of claim 1, wherein the acquiring of the address information of the mobile node comprises:
receiving layer 2 address information of the mobile node from the access point; and
transmitting the layer 3 address information of the agent to the mobile node, and receiving permanent address information of the mobile node from the mobile node.

3. The method of claim 2, wherein the transmitting of the address information of the mobile node and the layer 3 address information of the correspondent node and the registering of the location of the mobile node comprises:
transmitting the layer 2 address information of the mobile node and the layer 3 address information of the agent to the management unit; and
transmitting the permanent address information of the mobile node to the management unit.

4. The method of claim 2, wherein the transmitting of the address information of the mobile node and the layer 3 address information of the correspondent node and the registering of the location of the mobile node further comprise transmitting layer 3 address information of the mobile node available on an access network area managed by the agent and temporarily allocated to the mobile node.

5. The method of claim 1, wherein the receiving and transmitting of the data packet between the mobile node and the correspondent node comprises:
receiving the data packet from the mobile node;
acquiring layer 3 address information of a different agent which manages a correspondent node having a destination address of the data packet; and
transmitting the data packet to the different agent using the layer 3 address information of the different agent.

6. The method of claim 5, wherein the acquiring of the layer 3 address information of the different agent comprises:
requesting the layer 3 agent information of the different agent which is to receive the data packet, to the management unit, using the destination address of the data packet; and
receiving the layer 3 address information of the different agent from the management unit in response to the request.

7. The method of claim 6, wherein the receiving and transmitting of the data packet between the mobile node and the correspondent node comprises buffering the data packet before the data packet is transmitted to the different agent.

8. The method of claim 5, wherein the receiving and transmitting of the data packet between the mobile node and the correspondent node comprises receiving the data packet from the mobile node, encapsulating the data packet, transmitting the encapsulated data packet to the different agent, receiving the encapsulated data packet from the different agent, and decapsulating the encapsulated data packet, and then transmitting the decapsulated data packet to the mobile node.

9. The method of claim 1, wherein the agent communicates with the management unit through at least one predetermined control channel.

10. The method of claim 9, wherein, if multiple protocol label switching is implemented in the Internet protocol core network, the agent communicates with the management unit using at least one label switch path as a control channel.

11. A method of supporting mobility of a node located on an Internet protocol core network and wirelessly connected to an access point, the method performed by a management unit capable of communicating with an agent for each access network, the agent managing the node, the method comprising:
acquiring layer 2 address information and permanent address information of the node, and layer 3 address information of the agent for each access network, from the agent for each access network;
mapping and managing the layer 2 address information and the permanent address information of the node and the layer 3 address information of the agent;
receiving a request message for requesting layer 3 address information of a receiving party agent which manages a correspondent node, from a transmitting party agent which tries to transmit a data packet to the correspondent node;
searching for the layer 3 address information of the receiving party agent from the layer 2 address information and the permanent address information of the node and the layer 3 address information of the agent, in response to the request message; and
transmitting the layer 3 address information of the receiving party agent to the transmitting party agent.

12. The method of claim 11, wherein the request message includes information about a source address and a destination address of the data packet, and
the searching for searching for the layer 3 address information of the receiving party agent comprise:
searching for permanent address information matched to the destination address of the data packet; and
searching for layer 3 address information of an agent mapped to the searched permanent address.

13. The method of claim 12, further comprising:
searching for permanent address information matched to the source address of the data packet and location information of the agent mapped to the searched permanent address, from the layer 2 address information and the permanent address information of the node and the layer 3 address information of the agent, in response to the request message; and
transmitting the permanent address information matched to the source address of the data packet, and the layer 3 address information of the agent mapped to the permanent address, to the receiving party agent.

14. A method of supporting mobility of a node located on an Internet protocol core network and wirelessly connected to an access point, the method performed by a management unit capable of communicating with an agent for each access network, the agent managing the node, the method comprising:
receiving layer 2 address information for registering a location of the node connected to the access point, and layer 3 address information of the agent, from the agent;
updating a table in which layer 2 addresses and permanent addresses of a plurality of nodes and layer 3 address information of an agent for managing the plurality of nodes are mapped and stored, using the received layer 2 address information and the received layer 3 address information; and
transmitting permanent addresses of all correspondent nodes communicating with a mobile node, and layer 3 address information of an agent mapped to the permanent addresses to the mobile node.

15. The method of claim 14, further comprising:
transmitting a permanent address of the mobile node and layer 3 address information of an agent mapped to the permanent address, to the all correspondent nodes communicating with the mobile node.

16. A method of supporting mobility of a mobile node, the method performed by an access point communicating with an agent which connects an access network to an Internet protocol core network, the method comprising:
forming a wireless channel with a mobile node;
acquiring layer 2 address information of the mobile node when the wireless channel is formed; and
transmitting the layer 2 address information of the mobile node to an agent for registering a location of the mobile node, instead of the mobile node.

17. An apparatus of supporting mobility of a mobile node for each access network, the apparatus which connects an access network to an Internet protocol core network integrating the plurality of access networks, the apparatus comprising:
a management unit managing information related to a mobile node connected to an access point, and managing information related to a correspondent node connected to an access point of a different access network; and
a reception/transmission processor receiving and transmitting a data packet between the mobile node and the correspondent node using the information managed by the management unit.

18. The apparatus of claim 17, wherein the management unit maps and manages layer 2 address information and permanent address information of the mobile node, and information about an interface to an access point connected to the mobile node, and maps and manages permanent address information of the correspondent node and layer 3 address information of a mobility supporting unit for managing the correspondent node.

19. A management apparatus for communicating with an agent for each access network, the management apparatus located on an Internet protocol core network, the agent managing a node wirelessly connected to an access point, the management apparatus comprising:
a central management unit managing permanent address information of a plurality of nodes connected to an access point, and layer 3 address information of an agent for managing the plurality of nodes, and managing communication connections between the plurality of nodes; and
transmitting permanent address information of a correspondent node managed by the central management unit, and layer 3 address information of an agent managing the correspondent node, in response to a request of an agent which manages a mobile node trying to communicate with the correspondent node, and transmitting permanent address information of the mobile node managed by the central management unit and layer 3 address information of the agent managing the mobile node, to the correspondent node.

20. The management apparatus of claim 19, wherein the information providing unit transmits permanent address information of at least one correspondent node which is in a communication connection status with the mobile node, information about the communication connection status managed by the central management unit, and layer 3 address information of an agent managing the correspondent node, to an agent newly managing the mobile node, according to a request from the agent newly managing the mobile node, when the mobile node performs handover, and transfers the permanent address information of the mobile node and layer 3 address information of the agent newly managing the mobile node to the at least one correspondent node.
